(19) United States
(12) Patent Application Publication
(10) Pub. No.: US 2014/0324799 A1
(43) Pub. Date: Oct. 30, 2014

(54) DATA PROCESSING APPARATUS, DATA PROCESSING METHOD, AND COMPUTER PROGRAM PRODUCT

(71) Applicant: KABUSHIKI KAISHA TOSHIBA, Tokyo (JP)

(72) Inventors: Masataka Goto, Yokohama-shi (JP); Nobuhiko Sugasawa, Shinagawa-ku (JP); Yuta Kobayashi, Kawasaki-shi (JP); Shinya Murai, Kawasaki-shi (JP)

(73) Assignee: KABUSHIKI KAISHA TOSHIBA, Tokyo (JP)

(21) Appl. No.: 14/174,975

(22) Filed: Feb. 7, 2014

(30) Foreign Application Priority Data
Apr. 26, 2013 (JP) 2013-094234

(51) Int. Cl. G06F 17/30; G06F 11/14

(52) U.S. Cl. CPC G06F 17/30135; G06F 11/14; G06F 17/30091
USPC 707/693

(57) ABSTRACT

According to an embodiment, a data processing apparatus includes a first generating unit, a second generating unit, a transfer instructing unit, and a transfer controller. The first generating unit generates transfer instruction information that specifies a storage position of transfer data in a data transfer source, a storage position of the transfer data in a data transfer destination, and a data transfer size, when the first generating unit determines that data transfer from a first storage unit to a second storage unit is required. The second generating unit generates fragment-transfer instruction information that is obtained by fragmenting the transfer instruction information into fragments of a predetermined data size. The transfer instructing unit instructs to perform data transfer based on the fragment-transfer instruction information. The transfer controller controls the data transfer between the first storage unit and the second storage unit according to instruction of the data transfer.

### CROSS-REFERENCE TO RELATED APPLICATIONS

This application is based upon and claims the benefit of priority from Japanese Patent Application No. 2013-094234, filed on Apr. 26, 2013; the entire contents of which are incorporated herein by reference.

### FIELD

Embodiments described herein relate generally to a data processing apparatus, a data processing method, and a computer program.

### BACKGROUND

Conventionally, data processing apparatuses that have a direct memory access (DMA) controller have been known. In such data processing apparatuses, direct data transfer from a main storage device to a nonvolatile storage device by a DMA controller is enabled instead of a central processing unit (CPU). Thereby, reduction of time required for data transfer can be achieved in the conventional data processing apparatuses.

However, in the conventional data processing apparatuses, when data is fragmented to small pieces, the CPU is required to generate transfer instruction information at each data transfer. Therefore, in the conventional data processing apparatuses, the CPU can be put under a heavy processing load.

### BRIEF DESCRIPTION OF THE DRAWINGS

FIG. 1 is a configuration diagram of a data processing apparatus according to an embodiment;

FIG. 2 is a diagram showing a functional configuration and an operation example of the data processing apparatus according to the embodiment;

FIG. 3 is a diagram showing an example of a virtual memory space according to the embodiment;

FIG. 4 is a diagram showing an example of a page table according to the embodiment;

FIG. 5 is a flowchart showing an example of a processing procedure at data processing according to the embodiment; and

FIG. 6 is a sequence diagram showing an example of a processing procedure at data transfer according to the embodiment.

### DETAILED DESCRIPTION

According to an embodiment, a data processing apparatus includes a first generating unit, a second generating unit, a transfer instructing unit, and a transfer controller. The first generating unit is configured to generate transfer instruction information that specifies a storage position of transfer data in a data transfer source, a storage position of the transfer data in a data transfer destination, and a data transfer size, when the first generating unit determines that data transfer from a first storage unit to a second storage unit is required. The second generating unit is configured to generate fragment-transfer instruction information that is obtained by fragmenting the transfer instruction information into fragments of a predetermined data size. The transfer instructing unit is configured to instruct to perform data transfer based on the fragment-transfer instruction information. The transfer controller is configured to control the data transfer between the first storage unit and the second storage unit according to instruction of the data transfer.

An embodiment is explained in detail below with reference to the accompanying drawings.

Data Processing Apparatus

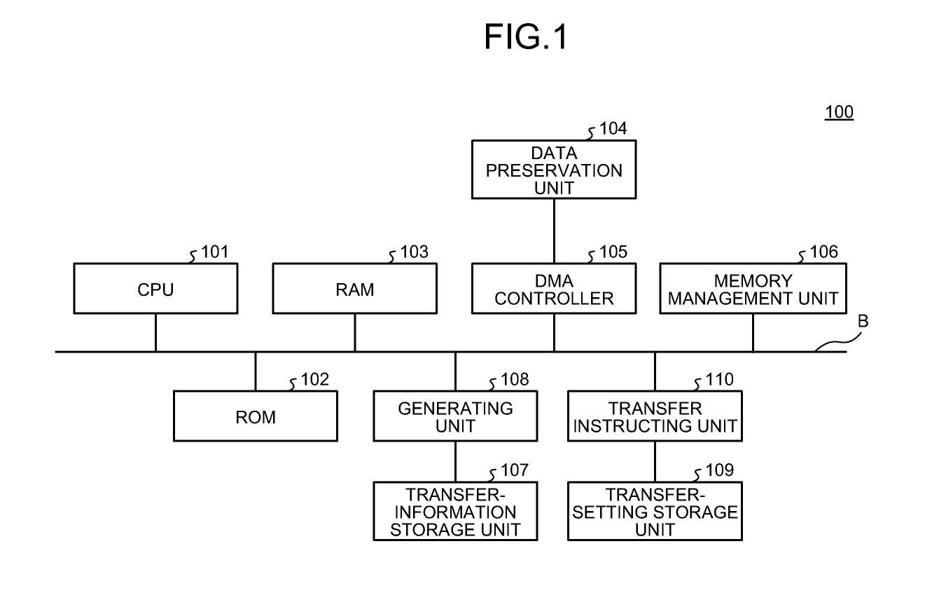

FIG. 1 is a configuration diagram of a data processing apparatus 100 according to a present embodiment. As shown in FIG. 1, the data processing apparatus 100 according to the present embodiment includes a CPU 101, a read only memory (ROM) 102, a random access memory (RAM) 103, a data preservation unit 104, and a DMA controller 105. Furthermore, the data processing apparatus 100 according to the present embodiment includes a memory management unit 106, a transfer-information storage unit 107, a generating unit 108, a transfer-setting storage unit 109, and a transfer instructing unit 110. In the data processing apparatus 100 according to the present embodiment, respective pieces of hardware are connected through a bus B, and data is communicated through the bus B. An example in which the respective pieces of hardware are connected through a single line of the bus B is shown in FIG. 1, and connection is established, for example, based on a standard such as a peripheral component interconnect (PCI) bus.

The CPU 101 is a computing device that achieves control of the entire apparatus and installed functions. The ROM 102 is a nonvolatile memory in which programs and data are stored. The RAM 103 is a memory such as a static RAM (SRAM) and a dynamic RAM (DRAM), and is a volatile memory (main storage device) in which programs and data are read and temporarily held. Accordingly, for example, the CPU 101 reads programs and data from the ROM 102 onto the RAM 103 and performs processing, and thereby control of the entire apparatus or implementation of installed functions are achieved.

The data preservation unit 104 is a recording medium such as a hard disk drive (HDD) and a memory card, and is a nonvolatile storage device that stores application programs and data. The DMA controller 105 is a control device that controls data transfer performed between the RAM 103 and the data preservation unit 104.

The memory management unit 106 is a unit that provides a virtual storage region (hereinafter, “virtual memory space”) that is separated from a storage region (hereinafter, “memory space”) in the RAM 103 to an application program and the like. The memory management unit 106 manages the memory space and the virtual memory space using a page table (page managing information) in which a virtual page and a physical page are associated with each other.

The transfer-information storage unit 107 is a volatile memory in which data such as transfer instruction information indicating an instruction of data transfer is stored. The generating unit 108 generates fragment-transfer instruction information that corresponds to fragmented data at the time of data transfer according to specifications of the DMA controller 105 based on transfer instruction information.

The transfer-setting storage unit 109 is a volatile memory in which data such as setting at data transfer (hereinafter, “data transfer setting”) to the DMA controller 105 and the data preservation unit 104 and a processing procedure for interrupt control at data transfer (hereinafter, “interrupt processing procedure”) is stored. The transfer instructing unit 110 is a control unit that performs data transfer setting, data transfer instruction, interrupt control, or the like with respect to the DMA controller 105 and the data preservation unit 104 based on the data transfer setting and the interrupt processing procedure.

As described above, the data processing apparatus 100 according to the present embodiment can provide a data processing function of transferring data recorded in the RAM 103 to the data preservation unit 104 to be stored therein with the above configuration.

Data Processing Function

A data processing function according to the present embodiment is to be explained. The data processing apparatus 100 according to the present embodiment has the generating unit 108 and the transfer instructing unit 110, functions of which are implemented by separate devices (for example, a hardware logic such as “circuit”) from the CPU 101. The data processing apparatus 100 generates, when the CPU 101 determines that data transfer from the RAM 103 to the data preservation unit 104 is required, transfer instruction information that specifies a storage position of the transfer data in a data transfer source, a storage position of the transfer data in a data transfer destination, a data transfer size, and the like. In the data processing apparatus 100, the generating unit 108 generates fragment-transfer instruction information that is obtained by fragmenting the transfer instruction information into fragments of respective transfer data sizes according to specifications of the DMA controller 105. In the data processing apparatus 100, the transfer instructing unit 110 instructs the DMA controller 105 to perform data transfer based on the fragment-transfer instruction information. The data processing apparatus 100 according to the present embodiment has such a data processing function.

Data processing includes saving data in the data preservation unit 104 each time the data in the RAM 103 is rewritten, to prevent data corruption or data loss.

In a conventional data processing apparatus, the CPU 101 generates the fragment-transfer instruction information including information on a fragmented data size or attribute information for each piece of data at each data transfer, and therefore, the CPU 101 is under a heavy processing load when such data processing requiring frequent data transfer as above is performed. In addition, in a conventional data processing apparatus, interrupt signals are frequently issued from the DMA controller 105 to the CPU 101 at the time of data transfer, and therefore, the CPU 101 is under a high processing load.

Therefore, in the data processing function according to the present embodiment, such a system is achieved that generation of the fragment-transfer instruction information to be given to the DMA controller 105 and instruction of data transfer to the DMA controller 105 are implemented by separate devices from the CPU 101, and independency of the CPU 101 at data transfer is enhanced.

A configuration and an operation of the data processing function according to the present embodiment are to be explained. In the present embodiment, the RAM 103 corresponds to the storage device of a transfer source (first storage device) and the data preservation unit 104 corresponds to the storage device of a data transfer destination (second storage device). Furthermore, the DMA controller 105 functions as a data-transfer controller to control data transfer between the RAM 103 and the data preservation unit 104.

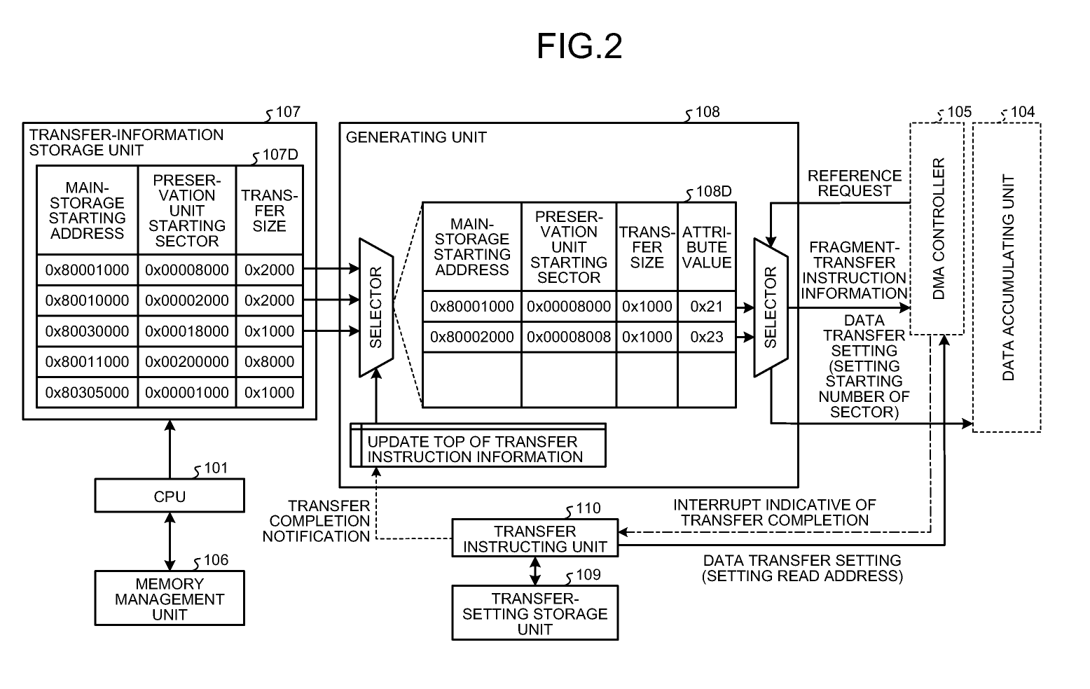

FIG. 2 is a diagram showing a functional configuration and an operation example of the data processing according to the present embodiment. The CPU 101 according to the present embodiment generates transfer instruction information 107D of transfer data, and the generated transfer instruction information 107D is stored in the transfer-information storage unit 107. The CPU 101 generates the transfer instruction information 107D in response to an update (rewrite) of data in the RAM 103. That is, in the present embodiment, when the CPU 101 detects a data update in the RAM 103, the CPU 101 determines that data transfer from the RAM 103 to the data preservation unit 104 is required.

The transfer instruction information 107D generated by the CPU 101 according to the present embodiment is explained herein. As shown in FIG. 2, the transfer instruction information 107D has information fields such as a main-storage starting address, an preservation-unit starting sector, and a transfer size. Field values of the respective information fields are associated with each other, and are managed as one entry.

The main-storage starting address is information (storage position information of a data transfer source) indicating an address in the RAM 103 of transfer data to be stored in the data preservation unit 104. The preservation-unit starting sector is information indicating a starting number of a sector (storage position information of a data transfer destination) in which the transfer data is to be stored in the data preservation unit 104. The transfer size is information indicating a data size (data-transfer size information) of the transfer data to be stored in the data preservation unit 104. The information fields of the transfer instruction information 107D are not limited thereto. The information field shown in FIG. 2 is one example, and for example, an additional information field can be added based on a device type of the data preservation unit 104. The additional information field can be, for example, of a bit value (flag information) indicating whether an entry is valid, a timer value (data-transfer interval information) indicating an operation interval of data transfer between entries, and the like.

For example, in the transfer instruction information 107D shown in FIG. 2, an example in which transfer data of ‘0x2000’ [bytes], the address in the RAM 103 of which starts with ‘0x80001000’, is managed as the first entry is shown. Furthermore, an example in which the starting number of a sector when storing the transfer data in the data preservation unit 104 is ‘0x8000’ is shown.

As described, the CPU 101 according to the present embodiment generates the transfer instruction information 107D including a main-storage starting address, an preservation-unit starting sector, a transfer size, and the like in a unit of successive data in the RAM 103 or in a unit of successive data in the data preservation unit 104. Therefore, the transfer instruction information 107D is generated by the CPU 101 as many pieces as the number of fragmented pieces of data.

A generating method of the transfer instruction information 107D by the CPU 101 according to the present embodiment is explained in detail below.

Generally, an operating system (OS) has a virtual memory function that provides a virtual memory space, which is an individual storage area, to individual application programs.

The virtual memory space is implemented by virtually configuring a memory space in the RAM 103 to be provided to an application program. In the virtual memory space, for example, data required for executing an application program is temporarily held in the RAM 103 or temporarily saved in the data preservation unit 104.

The virtual memory space is managed as virtual pages fragmented into a predetermined size (page size: for example, ‘4096’ is a common size). Similarly, a memory space in the RAM 103 is also fragmented and managed in physical pages in the same size as the virtual pages. The memory management unit 106 provides the virtual memory space that is separated from the memory space in the RAM 103 to an application program, using a page table in which the virtual pages and the physical pages are associated with each other.

Accordingly, the CPU 101 according to the present embodiment generates the transfer instruction information 107D at a time when the virtual memory function requires transfer of data of a virtual page from the physical page to the data preservation unit 104.

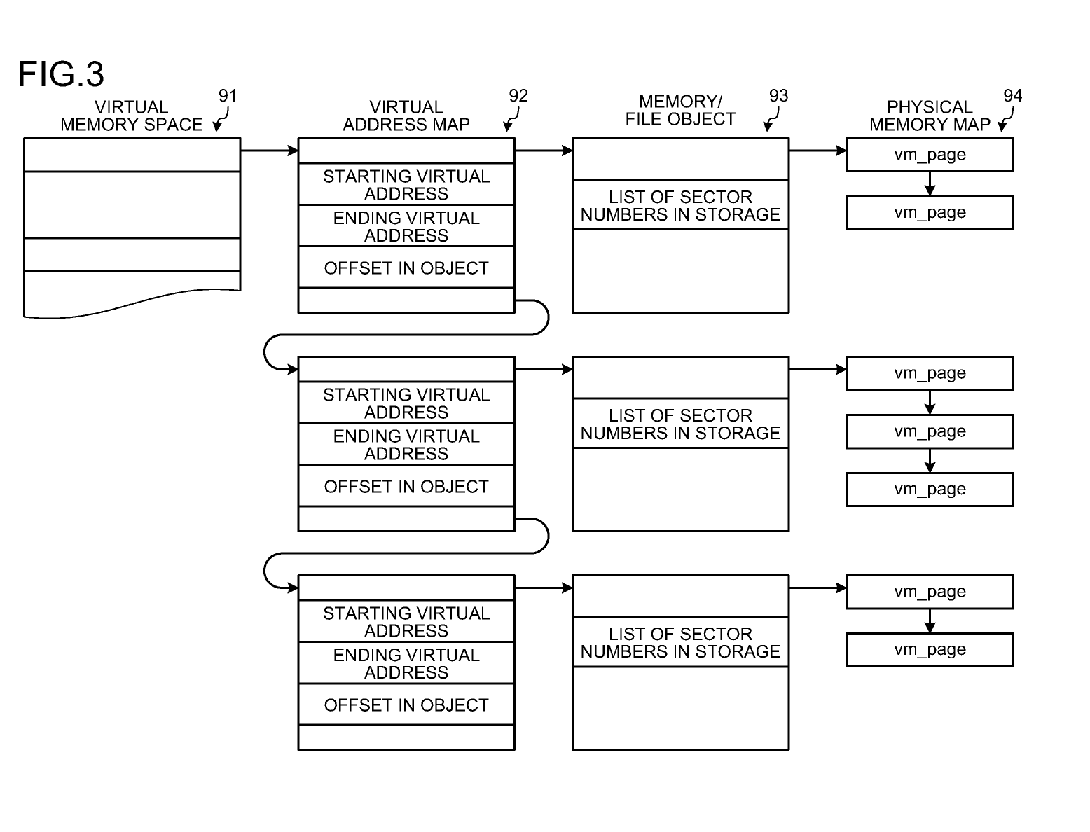

FIG. 3 is a diagram showing an example of a virtual memory space 91 according to the present embodiment. As shown in FIG. 3, the OS has a virtual address map 92 for each of the virtual memory spaces 91 that is provided to an application program by the OS. The virtual address map 92 has a starting virtual address, ending virtual address, an offset in an object, and the like, and is structured with tables in a chain form. The virtual address map 92 refers to a corresponding memory/file object 93.

The memory/file object 93 has a list of sector numbers in a storage (the data preservation unit 104), and the like. The list of sector numbers is more than one sector number on a storage having length that matches an area size of the virtual memory space 91 indicated by the virtual address map 92. The sector number corresponds to a sector number of the data preservation unit 104 in the present embodiment. Moreover, the memory/file object 93 refers to a physical memory map 94 that indicates a corresponding physical page in the RAM 103. The physical memory map 94 has a physical page that is expressed as “vmpage” in FIG. 3.

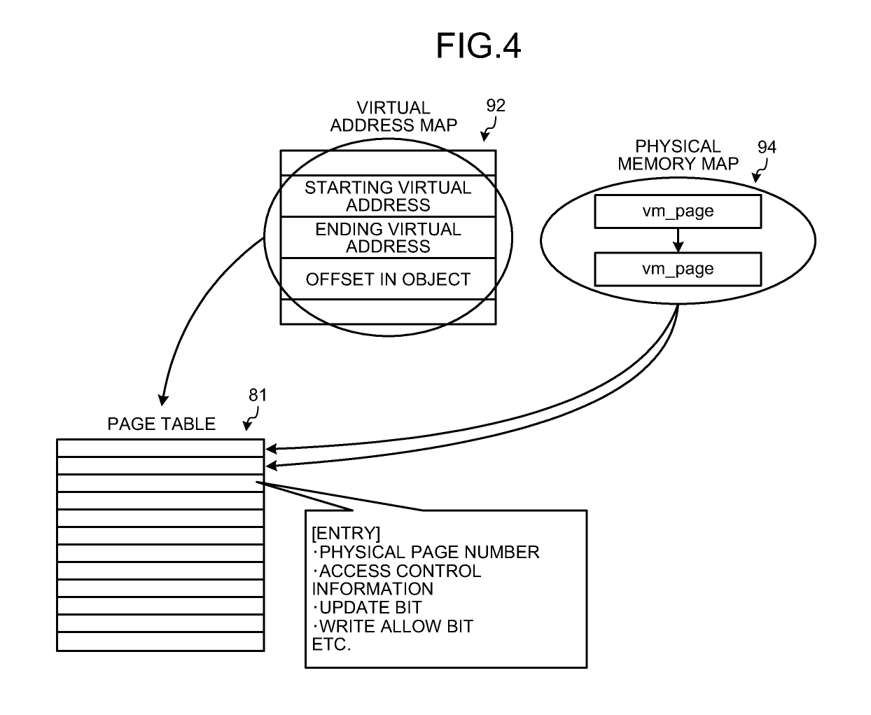

FIG. 4 is a diagram showing an example of a page table 81 according to the present embodiment. As shown in FIG. 4, the memory management unit 106 has the page table 81. To the page table 81, more than one entry of information field is made from the top of the virtual memory space 91. The information fields to be added as entries are generated from the virtual address map 92 and the physical memory map 94. The information fields to be generated include a physical page number that is expressed by a value obtained by dividing an address of the RAM 103 by a page size, an access control information that indicates access control to a physical page, and the like. Furthermore, the information fields to be generated include an update bit (update information) indicating that data of a physical page has been updated, a write allow bit (write allow information) indicating whether write to a physical page is allowed, and the like. The generated information field is associated with a field value as one entry, and is managed in the page table 81 for each virtual page. A structure and a managing method of the page table 81 are in accordance with specifications of the memory management unit 106.

The CPU 101 according to the present embodiment accesses the page table 81 held by the memory management unit 106, and detects whether data in the RAM 103 has been updated based on the update bit. Specifically, the CPU 101 generates the transfer instruction information 107D when the OS performs control of the virtual memory, by the following processing. The timing of control of the virtual memory performed by the OS can be when a predetermined time such as 30 [sec] has elapsed, when an executing process has been changed (when a context switch has been done), when a certain interrupt occurs, or the like. The timing of control of the virtual memory performed by the OS depends on specifications of the OS. First, the CPU 101 according to the present embodiment scans the page table 81 to search for an entry the update bit of which is ‘1’. The CPU 101 determines a data transfer destination from the corresponding entry, and searches for the virtual address map 92, the memory/file object 93, and the physical memory map 94 that match the entry number of the virtual page.

Consequently, the CPU 101 according to the present embodiment generates an entry of the transfer instruction information 107D by the following calculating formulas Equation (1) to Equation (3) using values obtained from the page table 81 that corresponds to the physical page with updated data based on the result of the search.

main-storage starting address=(physical page number)×(page size) (1)

where the physical page number indicates a physical page number that is held by the physical page “vm_page” at the top of the physical memory map 94, and the page size indicates a size value (for example, 4096 [bytes]) of the physical page.

preservation-unit starting sector=(sector number) (2)

where the sector number indicates a sector number at the top of the sector number list in a storage of the memory/file object 93.

transfer size=(ending virtual address)−(starting virtual address) (3)

where the ending virtual address indicates an ending virtual address of the virtual address map, and the starting virtual address indicates a starting virtual address of the virtual address map.

In this way, the CPU 101 according to the present embodiment uses detection of data update in the RAM 103 as a trigger to start data transfer. Upon detecting a data update in the RAM 103, the CPU 101 generates the transfer instruction information 107D that specifies a storage position of transfer data in the data transfer source, a storage position of transfer data in the data transfer destination, a data transfer size, and the like. That is, in the present embodiment, the CPU 101 functions as a generating unit (first generating unit) that generates the transfer instruction information 107D.

Explanation returns to FIG. 2. The generating unit 108 (second generating unit) generates fragment-transfer instruction information 108D. The generated fragment-transfer instruction information 108D is stored in a storage area (hereinafter, “internal storage area”) in the generating unit 108. Upon receiving a reference request to the internal storage area specified by a read address from the DMA controller 105, the generating unit 108 generates the fragment-transfer instruction information 108D based on the transfer instruction information 107D stored in the transfer-information storage unit 107. In other words, the generating unit 108 determines from which one piece of the transfer instruction information 107D in the transfer-information storage unit 107 to generate the fragment-transfer instruction information 108D, based on the read address for which the reference request has been issued.

At this time, the generating unit 108 generates multiple pieces of the fragment-transfer instruction information 108D from a single entry of the transfer instruction information 107D according to specifications of the DMA controller 105. Specifically, the generating unit 108 makes the transfer instruction information 107D into fragments based on the data size according to the specifications of the DMA controller 105 to generate multiple pieces of the fragment-transfer instruction information 108D. The generating unit 108 determines which entry of the transfer instruction information 107D is selected in the transfer-information storage unit 107. The generating unit 108 controls entry selection of the transfer instruction information 107D by inputting a control signal to a selector circuit.

The fragment-transfer instruction information 108D generated by the generating unit 108 according to the present embodiment is explained herein. As shown in FIG. 2, the fragment-transfer instruction information 108D includes information fields such as a main-storage starting address, an preservation-unit starting sector, a transfer size, and an attribute value, and is managed with field values of the respective information fields associated with each other.

The main-storage starting address represents a storage position information of a data transfer source. The preservation-unit starting sector represents storage position information of a data transfer destination. The transfer size represents data transfer size information. These information fields are the same as the information fields in the transfer instruction information 107D. On the other hand, the attribute value is information (end information) indicating the end of the fragmented transfer data when the transfer data corresponding to one entry of the transfer instruction information 107D is made into fragments, and is a information field of the fragment-transfer instruction information 108D. Because specifications differ in each of the DMA controller 105, to the attribute value, values according to the specification of the DMA controller 105 are set.

The structure of the fragment-transfer instruction information 108D is not limited thereto. The structure shown in FIG. 2 is one example, and it can take a structure according to a device type of the DMA controller 105 such as an array structure and a chain structure, for example.

For example, for the fragment-transfer instruction information 108D shown in FIG. 2, an example of the fragment-transfer instruction information 108D that is generated from the first entry of the transfer instruction information 107D is shown. In the present embodiment, an example in which transfer data of ‘0x2000’ [bytes] that is managed as one entry in the transfer instruction information 107D is fragmented in a unit of ‘0x1000’ according to the DMA controller 105 is shown. Specifically, when the transfer data having the starting address of ‘0x80001000’ in the RAM 103 is fragmented into two pieces of data, an attribute value ‘0x21’ (no end flag) indicating that it is not the end and an attribute value ‘0x23’ (end flag) indicating that it is the end are set to the respective pieces of fragment data. Moreover, an example in which the preservation-unit starting sector when the transfer data is stored in the data preservation unit 104 is ‘0x8000’ is shown.

In this way, the generating unit 108 according to the present embodiment first determines the fragment size of transfer data, the attribute value indicating the end of the transfer data, and the like based on the specifications of the DMA controller 105. Thereafter, the generating unit 108 generates the fragment-transfer instruction information 108D in a unit of read address for which a reference request has been issued, from the transfer instruction information 107D. The specifications of the DMA controller 105 that determine a fragmentation unit of transfer data, the attribute value indicating the end of transfer data, and the like are set in advance in the transfer-information storage unit 107 to be stored therein. Thus, the generating unit 108 fragments the transfer instruction information 107D into pieces of a data size according to the specifications of the DMA controller 105 based on setting information of the transfer-information storage unit 107, to generate the fragment-transfer instruction information 108D. The generating unit 108 outputs the generated fragment-transfer instruction information 108D as read data to the DMA controller 105 that has issued the reference request.

The transfer instructing unit 110 performs data transfer setting, data transfer instruction, interrupt control, or the like. The transfer instructing unit 110 performs the data transfer setting with respect to the DMA controller 105 by setting a read address to be specified when a reference request is sent to the generating unit 108. Thereby, the transfer instructing unit 110 instructs the DMA controller 105 to perform data transfer. Furthermore, the transfer instructing unit 110 performs the data transfer setting with respect to the data preservation unit 104 by setting a starting number of a sector in which the transfer data is to be stored. The transfer instructing unit 110 performs the data transfer setting based on sector numbers stored in advance in the transfer-setting storage unit 109.

When an interrupt signal is input from the DMA controller 105, the transfer instructing unit 110 performs interrupt control based on the input signal. The transfer instructing unit 110 performs the interrupt control according to an interrupt processing procedure that is stored in advance in the transfer-setting storage unit 109. When the interrupt control is completed, the transfer instructing unit 110 notifies the generating unit 108 of the completion thereof. The transfer instructing unit 110 performs interrupt control with respect to the DMA controller 105, for example, when an interrupt signal indicative of data transfer completion is input from the DMA controller 105, and notifies the generating unit 108 that data transfer has been completed.

In response to this, the generating unit 108 shifts a reference subject of the transfer instruction information 107D from the entry that has been referred to at the time of generating the fragment-transfer instruction information 108D to a next entry, and updates the top of the transfer instruction information 107D.

As described, in the present embodiment, processing performed by the CPU 101 at data transfer is only generating the transfer instruction information 107D. Thus, in the data processing apparatus 100 according to the present embodiment, processing of the CPU 101 performed at data transfer is reduced, and an interrupt from the DMA controller 105 does not occur. Therefore, a processing load on the CPU 101 can be reduced.

The data processing function according to the present embodiment described above is implemented by the respective functional units described above operating in cooperation in the data processing apparatus 100. In the present embodiment, the respective functions of the generating unit 108 and the transfer instructing unit 110 are implemented by separate devices from the CPU 101. Accordingly, the data processing function according to the present embodiment is implemented by a transfer-instruction information generating function that is implemented by executing a data processing program by the CPU 101, and the respective functions of the generating unit 108 and the transfer instructing unit 110 that are implemented by respectively independent devices operating in cooperation.

The data processing program is installed in advance in the ROM 102 equipped in the data processing apparatus 100 (computer), which is the execution environment, to be provided. The data processing program has a module structure including the respective functional units of the transfer-instruction information generating function, and by reading and the program from the ROM 102 by the CPU 101 to be executed, the respective functional units are generated on the RAM 103. The method of providing the data processing program is not limited thereto. For example, a method in which the data processing program is stored in a device that is connected to the Internet and downloaded through a network to be distributed can be taken. Moreover, a method in which a file in an installable form or an executable form is recorded in a recording medium that can be read by the data processing apparatus 100 to be provided can also be taken.

An operation of the data processing function (cooperative operation of the respective functional units) is explained below using a flowchart and a sequence diagram.

Operation at Data Processing

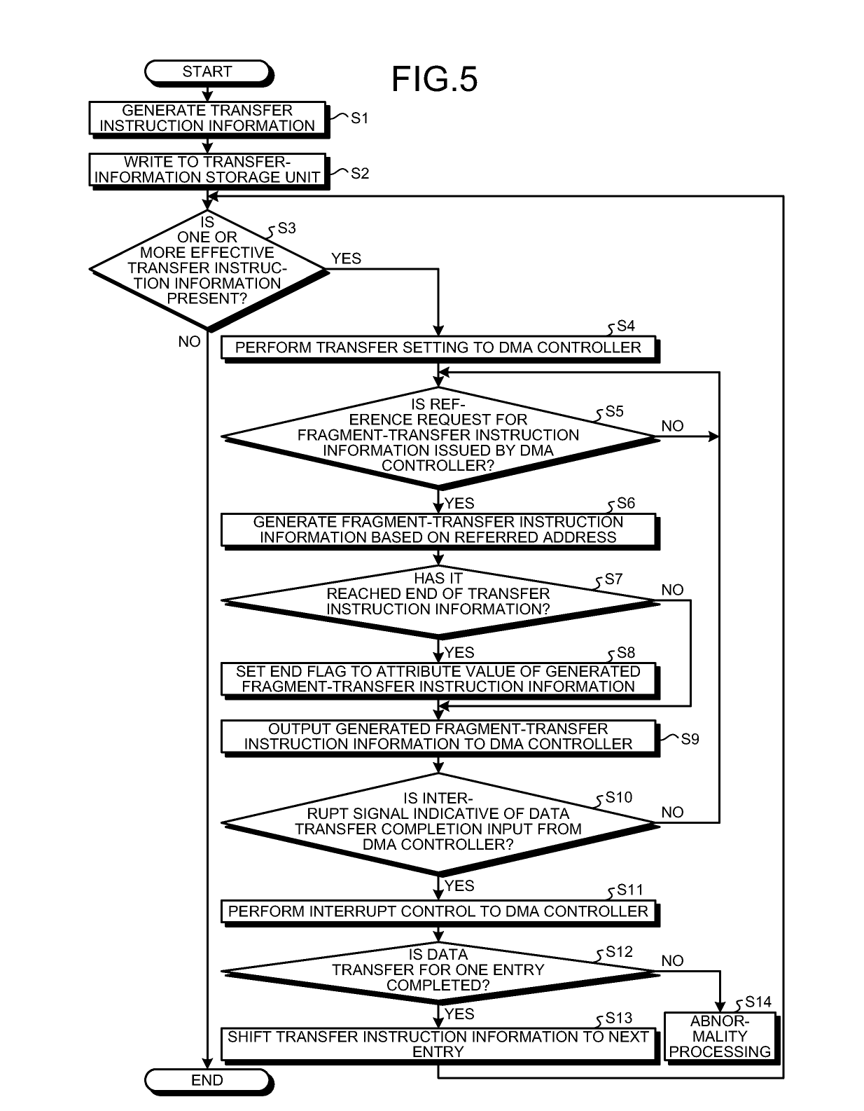

FIG. 5 is a flowchart showing an example of a processing procedure at data processing according to the present embodiment. As shown in FIG. 5, upon detecting a data update in the RAM 103, the CPU 101 generates the transfer instruction information 107D for transfer data on the RAM 103 (step S1), and writes the generated transfer instruction information 107D to the transfer-information storage unit 107 (step S2).

Subsequently, the transfer instructing unit 110 determines whether one or more pieces of the effective transfer instruction information 107D is present when data transfer to the DMA controller 105 is performed (when an instruction to actually start data transfer is issued from software) (step S3).

As a result, when the transfer instructing unit 110 determines that one or more pieces of the effective transfer instruction information 107D is present (step S3: YES), the transfer instructing unit 110 performs data transfer setting including setting of various conditions such as a read address for when a reference request is issued to the generating unit 108, with respect to the DMA controller 105 (step S4). Thus, when the DMA controller 105 issues a reference request for the fragment-transfer instruction information 108D to the generating unit 108 at the time of starting data transfer, an address specified in the read address is to be the reference start position of the fragment-transfer instruction information 108D. Furthermore, the transfer instructing unit 110 performs data transfer setting including setting of various conditions such as a starting number of a sector in which the transfer data is stored in the data preservation unit 104 at step S4. When the transfer instructing unit 110 determines that one or more pieces of the effective transfer instruction information 107D is not present (step S3: NO), the transfer instructing unit 110 finishes the processing.

The generating unit 108 determines whether a reference request for the fragment-transfer instruction information 108D has been issued from the DMA controller 105 (step S5).

When the generating unit 108 determines that a reference request for the fragment-transfer instruction information 108D has been issued (step S5: YES), the generating unit 108 generates the fragment-transfer instruction information 108D corresponding to an address for which the reference request has been issued, based on the transfer instruction information 107D generated by the CPU 101 (step S6). Specifically, the generating unit 108 determines from which one piece of the transfer instruction information 107D in the transfer-information storage unit 107 to generate the fragment-transfer instruction information 108D, based on the read address for which the reference request has been issued, and generates the data. At this time, the generating unit 108 determines a fragment size of the transfer data, an attribute value indicating the end of the transfer data, and the like according to the DMA controller 105. Thereafter, the generating unit 108 generates, from one entry of the transfer instruction information 107D, the fragment-transfer instruction information 108D for each of the read address for which the reference request has been issued. When the generating unit 108 determines that a reference request for the fragment-transfer instruction information 108D has not been issued (step S5: NO), the generating unit 108 shifts to the processing at step S5 to be in a standby state for a reference request.

Next, the generating unit 108 determines whether the generated fragment-transfer instruction information 108D has reached the end of the transfer data corresponding to the entry of the transfer instruction information 107D of the generating source (step S7). In other words, the generating unit 108 determines whether processing of generating the fragment-transfer instruction information 108D has been performed up to the end of the transfer data.

As a result, when the generating unit 108 determines that the generated fragment-transfer instruction information 108D has reached the end of the transfer data corresponding to the entry of the transfer instruction information 107D of the generating source (step S7: YES), the generating unit 108 sets a value of the end flag to the attribute value of the generated fragment-transfer instruction information 108D (step S8). Thereafter, the generating unit 108 outputs the generated fragment-transfer instruction information 108D to the DMA controller 105 that has issued the reference request (step S9). Thus, the DMA controller 105 can determine whether all pieces of the fragment-transfer instruction information 108D have been acquired based on the attribute value of the fragment-transfer instruction information 108D that is output in response to the reference request. When the generating unit 108 determines that the generated fragment-transfer instruction information 108D has not reached the end of the transfer data corresponding to the entry of the transfer instruction information 107D of the generating source (step S7: NO), the generating unit 108 sets a value of the no end flag to the attribute value of the generated fragment-transfer instruction information 108D, and performs the processing at step S9.

The transfer instructing unit 110 determines whether an interrupt signal indicative of data transfer completion is input from the DMA controller 105 (step S10). The DMA controller 105 performs data transfer to the data preservation unit 104 based on the fragment-transfer instruction information 108D output from the generating unit 108. Thus, the DMA controller 105 determines that all pieces of the fragment-transfer instruction information 108D have been acquired based on the attribute value of the fragment-transfer instruction information 108D, and issues an interrupt signal indicative of data transfer completion when the data transfer is completed.

Consequently, when the transfer instructing unit 110 determines that an interrupt signal indicative of data transfer completion has been input by the DMA controller 105 (step S10: YES), the transfer instructing unit 110 performs the interrupt control with respect to the DMA controller 105 (step S11).

On the other hand, when the transfer instructing unit 110 determines that an interrupt signal indicative of data transfer completion has not been input by the DMA controller 105 (step S10: NO), the transfer instructing unit 110 repeats the processing from step S5 again. Meanwhile, the generating unit 108 generates the fragment-transfer instruction information 108D in accordance with a reference request from the DMA controller 105. The generating unit 108 accepts, from the DMA controller 105, a reference request based on a next address following the address for which the reference request has been issued at the previous processing.

Subsequently, the transfer instructing unit 110 determines whether data transfer corresponding to one entry of the transfer instruction information 107D to be processed has been completed (step S12). At this time, the transfer instructing unit 110 determines whether the data transfer has been completed based on an interrupt signal indicative of data transfer completion that is input by the DMA controller 105. The interrupt signal of data transfer completion includes data of a result of data transfer indicating whether data transfer has been completed normally (hereinafter, “data-transfer result information). Therefore, the transfer instructing unit 110 determines whether data transfer has been completed based on the data-transfer result information included in the interrupt signal indicative of data transfer completion.

As a result, when the transfer instructing unit 110 determines that data transfer corresponding to one entry of the transfer instruction information 107D to be processed has been completed (step S12: YES), the transfer instructing unit 110 notifies the generating unit 108 that data transfer has been completed. In response to this, the generating unit 108 shifts the entry (reference destination) of the transfer instruction information 107D to be processed to a next entry (step S13), and updates the top of the transfer instruction information 107D. Thereafter, the data processing according to the present embodiment is shifted to the processing at step S3 again, and is continued while the effective transfer instruction information 107D is present.

When the transfer instructing unit 110 determines that data transfer corresponding to one entry of the transfer instruction information 107D of a processing subject has been completed (step S12: NO), the transfer instructing unit 110 performs abnormality processing (step S14). The abnormality processing performed at this time includes an error display to a display screen, an error notification by an e-mail, and the like.

Operation at Data Transfer

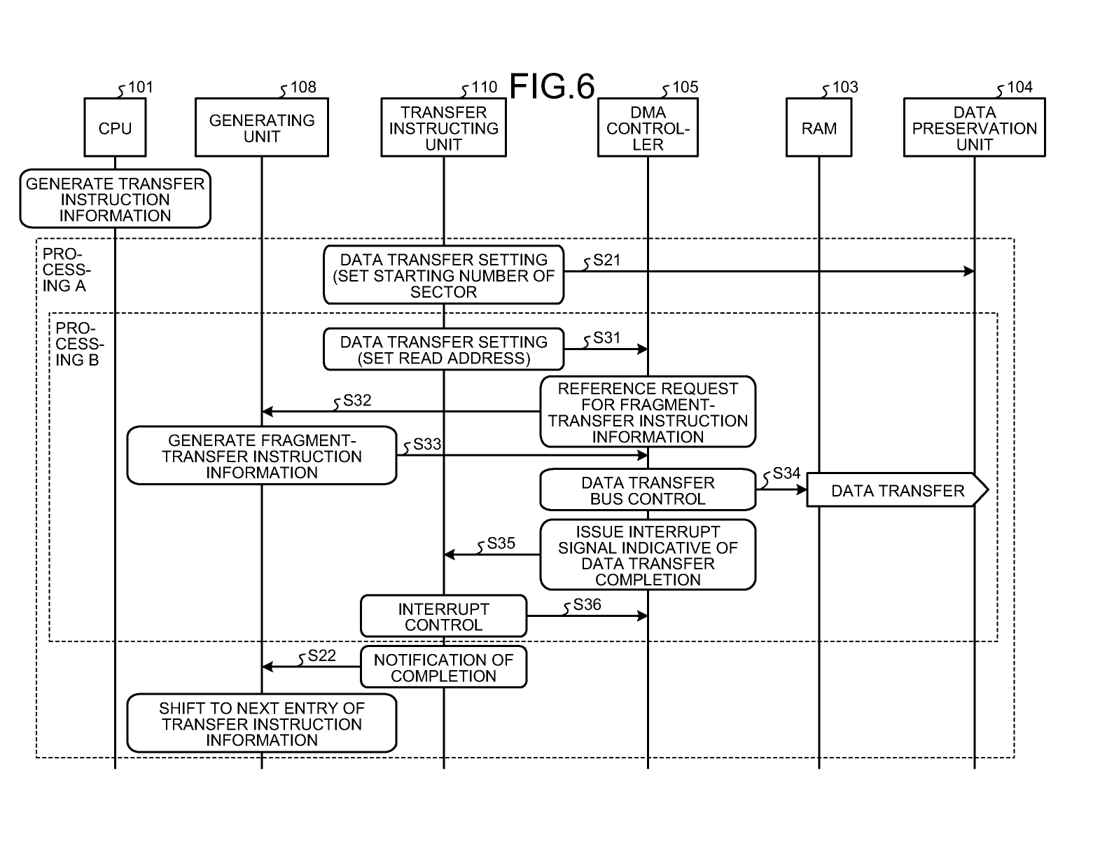

FIG. 6 is a sequence diagram showing an example of a processing procedure at data transfer according to the present embodiment. In FIG. 6, an operation example of data transfer performed by the DMA controller 105 that is executed in the data processing described above is shown.

As shown in FIG. 6, data transfer according to the present embodiment is performed after the CPU 101 generates the transfer instruction information 107D upon detecting a data update in the RAM 103 and the generated transfer instruction information 107D is stored in the transfer-information storage unit 107.

The data transfer according the present embodiment includes processing A and processing B shown in FIG. 6 mainly. Processing A is repeatedly performed for each entry of the transfer instruction information 107D. Processing B is repeatedly performed in Processing A for each transfer data fragmented.

In Processing A, upon detecting a presence of the effective transfer instruction information 107D, the transfer instructing unit 110 sets a starting number of a sector in which the transfer data is stored with respect to the data preservation unit 104, to perform the data transfer setting (step S21).

Subsequently, Processing B is performed in Processing A and when completion of data transfer corresponding to one entry of the transfer instruction information 107D to be processed is detected, the generating unit 108 is notified of completion of the data transfer (step S22). In response to this, the generating unit 108 shifts the entry of the transfer instruction information 107D to be processed to a next entry.

As described, Processing A is repeatedly performed for each entry of the transfer instruction information 107D while a presence of the effective transfer instruction information 107D is detected.

In Processing B, the following processing is performed by the generating unit 108, the transfer instructing unit 110, and the DMA controller 105.

First, the transfer instructing unit 110 sets a read address to be specified when a reference request is issued to the generating unit 108 with respect to the DMA controller 105 to perform the data transfer setting (step S31). Subsequently, the DMA controller 105 requests reference of the fragment-transfer instruction information 108D to the generating unit 108 based on the set read address (step S32). In response to this, the generating unit 108 generates the fragment-transfer instruction information 108D corresponding to the address for which reference has been requested based on the transfer instruction information 107D, and outputs the generated fragment-transfer instruction information 108D to the DMA controller 105 (step S33).

Consequently, the DMA controller 105 controls the bus B corresponding to a data transmission path between the RAM 103 and the data preservation unit 104 (step S34), and thereby performs data transfer from the RAM 103 to the data preservation unit 104 based on the fragment-transfer instruction information 108D. At this time, the DMA controller 105 performs the data transfer from the RAM 103 to the data preservation unit 104 based on the main-storage starting address, the transfer size, and the preservation-unit starting sector in the fragment-transfer instruction information 108D. Specifically, data of the transfer size that is positioned at the main-storage starting address in the RAM 103 is transferred to the data preservation unit 104 and written at the position of the preservation-unit starting sector.

When data transfer is completed, the DMA controller 105 issues an interrupt signal indicative of data transfer completion to the transfer instructing unit 110 (step S35). At this time, the DMA controller 105 issues the interrupt signal indicative of data transfer completion based on the attribute value of the fragment-transfer instruction information 108D. Specifically, when the attribute value is the value of the end flag, it is determined that the data transfer has been completed, and the interrupt signal indicative of data transfer completion is issued. In response to this, the transfer instructing unit 110 performs the interrupt control with respect to the DMA controller 105 (step S36).

The DMA controller 105 does not issue an interrupt signal indicative of data transfer completion when the attribute value of the fragment-transfer instruction information 108D is not the value of the end flag. Thus, in Processing B, data transfer setting to the DMA controller 105 is repeatedly performed by the transfer instructing unit 110 until transfer of data of the transfer size that is specified in the entry of the transfer instruction information 107D to be processed is completed. As a result, the DMA controller 105 repeats data transfer as many times as the number of pieces of fragmented data.

As described, in the data processing according to the present embodiment, processing such as generation of the fragment-transfer instruction information 108D to be passed to the DMA controller 105, and instruction of data transfer to the DMA controller 105 is performed independently of processing of generating the transfer instruction information 107D performed by the CPU 101.

Summary

As described, according to the data processing apparatus 100 of the present embodiment, when the CPU 101 determines that data transfer from the RAM 103 to the data preservation unit 104 is required, the CPU 101 generates the transfer instruction information 107D that specifies a storage position of transfer data in a data transfer source, a storage position of the transfer data in a data transfer destination, a data transfer size, and the like. In the data processing apparatus 100, the generating unit 108, the function of which is implemented by a separate device from the CPU 101, generates the fragment-transfer instruction information 108D that is obtained by fragmenting the transfer instruction information 107D into fragments of the transfer data size in accordance with the specifications of the DMA controller 105. In the data processing apparatus 100, the transfer instructing unit 110, the function of which is implemented by a separate device from the CPU 101, instructs the DMA controller 105 to perform data transfer based on the fragment-transfer instruction information 108D.

Thus, the data processing apparatus 100 according to the present embodiment achieves generation of the fragment-transfer instruction information 108D to be passed to the DMA controller 105, instruction of data transfer to the DMA controller 105, and the like with separate devices from the CPU 101, and provides a system to enhance the independency of the CPU 101 at the time of data transfer. As a result, in the data processing apparatus 100 according to the present embodiment, processing of the CPU 101 at data transfer is few, and interrupt by the DMA controller 105 does not occur. Therefore, a processing load on the CPU 101 can be reduced.

Although in the embodiment described above, an example in which the respective functions of the generating unit 108 and the transfer instructing unit 110 are implemented by a hardware logic (implementation of hardware) of separate devices from the CPU 101 has been explained, it is not limited thereto. For example, the respective functions of the generating unit 108 and the transfer instructing unit 110 can be implemented by executing a program (software). If the respective functions of the generating unit 108 and the transfer instructing unit 110 are implemented by executing a program, it is preferable that the program be designed considering reduction of a processing load on the CPU 101.

Furthermore, although in the embodiment described above, explanation has been given using an example in which a trigger to start data transfer (criterion for determining whether data transfer is required) is detection of a data update in the RAM 103 by the CPU 101, it is not limited thereto. For example, the trigger to start data transfer can be a condition requiring data to be saved in the data preservation unit 104 from the RAM 103 such as when power is turned off, or when it goes into hibernation. In this case, in the data processing apparatus 100 according to the present embodiment, data in the RAM 103 can be saved into the data preservation unit 104 steadily without placing a processing load on the CPU 101. Therefore, in the data processing apparatus 100 according to the present embodiment, processing time for hibernation processing (data saving processing) can be reduced, and speeding up of processing can be achieved.

Moreover, although in the embodiment described above, explanation has been given using a configuration including the CPU 101 that generates the transfer instruction information 107D as an example, it is not limited thereto. The data processing apparatus 100 according to the present embodiment can be included in a system that refers to the transfer instruction information 107D generated by a processor installed in another device to implement the data processing function.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising:
a first generating unit configured to generate transfer instruction information that specifies a storage position of transfer data in a data transfer source, a storage position of the transfer data in a data transfer destination, and a data transfer size, when the first generating unit determines that data transfer from a first storage unit to a second storage unit is required;
a second generating unit configured to generate fragment-transfer instruction information that is obtained by fragmenting the transfer instruction information into fragments of a predetermined data size;
a transfer instructing unit configured to instruct to perform data transfer based on the fragment-transfer instruction information; and
a transfer controller configured to control the data transfer between the first storage unit and the second storage unit according to instruction of the data transfer.

2. The apparatus according to claim 1, wherein
when the first generating unit detects a data update in the first storage unit based on update data, the first generating unit determines that the data transfer from the first storage unit to the second storage unit is required, the update data being included in page managing data in which a virtual page of a virtual memory space and a physical page in a memory space of the first storage unit which is a main storage unit, are associated with each other, and indicating a data update of the physical page.

3. The apparatus according to claim 2, wherein
the first generating unit generates the transfer instruction information based on the page managing information corresponding to the physical page in which data is updated.

4. The apparatus according to claim 1, wherein
the second generating unit generates the fragment-transfer instruction information by fragmenting the transfer instruction information into fragments of the data size according to specifications of the transfer controller, and outputs the generated fragment-transfer instruction information to the transfer controller.

5. The apparatus according to claim 1, wherein
the first generating unit is implemented by executing software by a processor, and
at least one of the second generating unit, the transfer controller, and the transfer instructing unit is implemented by implementation of hardware that is separate from the processor.

6. The apparatus according to claim 1, wherein
upon receiving a reference request for the fragment-transfer instruction information from the transfer controller, the second generating unit determines the transfer instruction information to be fragmented based on an address that is specified by the transfer instructing unit.

7. The apparatus according to claim 1, wherein
the transfer instructing unit sets, to the transfer controller, an address specified when a reference request for the fragment-transfer instruction information is issued by the transfer controller.

8. The apparatus according to claim 1, wherein
the transfer controller issues, to the transfer instructing unit, an interrupt signal indicative of data transfer completion based on end information included in the fragment-transfer instruction information, the end information indicating an end of the transfer data, and
the transfer instructing unit performs interrupt control with respect to the transfer controller based on the interrupt signal received from the transfer controller, and notifies the second generating unit of completion of the data transfer.

9. The apparatus according to claim 1, wherein
the first generating unit, the second generating unit, the transfer controller, and the transfer instructing unit are implemented by implementation of respectively separate hardware.

10. A system that includes a processor, comprising:
a generating unit configured to generate fragment-transfer instruction information that is obtained by fragmenting transfer instruction information, which is generated when the processor determines that data transfer from a first storage unit to a second storage unit is required, into fragments of a predetermined data size, the transfer instruction information specifying a storage position of transfer data in a data transfer source, a storage position of the transfer data in a data transfer destination, and a data transfer size;
a transfer instructing unit configured to instruct to perform data transfer based on the fragment-transfer instruction information; and
a transfer controller configured to control the data transfer between the first storage unit and the second storage unit according to instruction of the data transfer.

11. A data processing method comprising:
generating transfer instruction information that specifies a storage position of transfer data in a data transfer source, a storage position of transfer data in a data transfer destination, and a data transfer size, when it is determined that data transfer from a first storage unit to a second storage unit is required;
generating fragment-transfer instruction information that is obtained by fragmenting the transfer instruction information into fragments of a predetermined data size;
instructing to perform data transfer based on the fragment-transfer instruction information; and
controlling the data transfer between the first storage unit and the second storage unit according to instruction of the data transfer.

12. A data processing method performed in a system including a processor, comprising:
generating fragment-transfer instruction information that is obtained by fragmenting transfer instruction information, which is generated when the processor determines that data transfer from a first storage unit to a second storage unit is required, into fragments of a predetermined data size, the transfer instruction information specifying a storage position of transfer data in a data transfer source, a storage position of the transfer data in a data transfer destination, and a data transfer size;
instructing to perform data transfer based on the fragment-transfer instruction information; and
controlling the data transfer between the first storage unit and the second storage unit according to instruction of the data transfer.

13. A computer program product comprising a computer-readable medium containing a data processing program that causes a computer to function as:
a first generating unit to generate transfer instruction information that specifies a storage position of transfer data in a data transfer source, a storage position of the transfer data in a data transfer destination, and a data transfer size, when the first generating unit determines that data transfer from a first storage unit to a second storage unit is required;
a second generating unit to generate fragment-transfer instruction information that is obtained by fragmenting the transfer instruction information into fragments of a predetermined data size; and
a transfer instructing unit configured to instruct a transfer controller, which controls data transfer between the first storage unit and the second storage unit, to perform data transfer based on the fragment-transfer instruction information.

14. A computer program product comprising a computer-readable medium containing a data processing program that causes, in a system including a processor, hardware separate from the processor to function as:
a generating unit to generate fragment-transfer instruction information that is obtained by fragmenting transfer instruction information, which is generated when the processor determines that data transfer from a first storage unit to a second storage unit is required, into fragments of a predetermined data size, the transfer instruction information specifying a storage position of transfer data in a data transfer source, a storage position of the transfer data in a data transfer destination, and a data transfer size; and
a transfer instructing unit to instruct a transfer controller, which controls data transfer between the first storage unit and the second storage unit, to perform data transfer based on the fragment-transfer instruction information.
